(19) United States
(12) Patent Application Publication
(10) Pub. No.: US 2020/0118136 A1
(43) Pub. Date: Apr. 16, 2020

(54) SYSTEMS AND METHODS FOR MONITORING MACHINE LEARNING SYSTEMS

(71) Applicant: MASTERCARD INTERNATIONAL INCORPORATED, Purchase, NY (US)

(72) Inventors: Xiaoying Zhang, O'Fallon, MO (US); Walter F. Lo Faro, St. Louis, MO (US); Ravi Santosh Arvapally, St. Louis, MO (US); Xianzhe Zhou, Town and Country, MO (US)

(21) Appl. No.: 16/653,126

(22) Filed: Oct. 15, 2019

Related U.S. Application Data
(60) Provisional application No. 62/746,359, filed on Oct. 16, 2018.

(51) Int. Cl. G06Q 20/40; G06N 20/00; G06K 9/62

(52) U.S. Cl. CPC G06Q 20/4016; G06K 9/6218; G06N 20/00

(57) ABSTRACT

Systems and methods are provided for performing anomaly detection. One exemplary method relates to transaction data including fraud scores output by a fraud score model generated by a machine learning system. The method includes accessing fraud scores for a segment of payment accounts for a target interval and for a series of similar intervals, generating a baseline distribution and a current distribution based on the fraud scores. A divergence value is then determined based on the baseline distribution and the current distribution. An activeness of the segment of payment accounts is also determined, and the operations are repeated for one or more other segments of payment accounts. The method further includes clustering the multiple divergence pairs and designated one or more of the multiple divergence pairs as abnormal based on the clustered divergence pairs.

### CROSS-REFERENCE TO RELATED APPLICATION

This application claims the benefit of, and priority to, U.S. Provisional Application No. 62/746,359 filed on Oct. 16, 2018. The entire disclosure of the above-referenced application is incorporated herein by reference.

### FIELD

The present disclosure generally relates to systems and methods for use in monitoring machine learning systems and, in particular, for performing anomaly detection for data generated by machine learning models, where the models are based on input data (e.g., fraud scores, etc.) provided through and/or stored in computer networks (e.g., in data structures associated with the computer networks, etc.).

### BACKGROUND

This section provides background information related to the present disclosure which is not necessarily prior art.

Machine learning (ML) systems are a subset of artificial intelligence (AI). In connection therewith, ML systems are known to generate models and/or rules, based on sample data provided as input to the ML systems.

Separately, payment networks are often configured to process electronic transactions. In connection therewith, people typically use payment accounts in electronic transactions processed via payment networks to fund purchases of products (e.g., good and services, etc.) from merchants. Transaction data, representative of such transactions, is known to be collected and stored in one or more data structures as evidence of the transactions. The transaction data may be stored, for example, by the payment networks and/or the issuers, merchants, and/or acquirers involved in the transactions processed by the payment networks. From time to time, fraudulent transactions are performed (e.g., unauthorized purchases, etc.) and transaction data is generated for the transactions, which is/are often designated and/or identified as fraudulent, for example, by a representative associated with the payment network who has investigated a transaction reported by a person as fraudulent. In some instances, ML systems are employed to build fraud models and/or rules, based on the transaction data for these fraudulent transactions, together with transaction data for non-fraudulent transactions, whereby the ML systems are essentially autonomously trained (i.e., the ML systems learn) how to build the fraud models and/or rules. As a result of the training, the ML systems, then, predict and/or identify potential fraudulent transactions within the network and generate scores, which are indicative of a likelihood of a future transaction in progress being fraudulent.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in performing anomaly detection on data generated and/or stored in data structures of a computer network/system;

FIG. 2 is a block diagram of a computing device that may be used in the exemplary system of FIG. 1;

FIG. 3 is an exemplary method that may be implemented in connection with the system of FIG. 1 for performing anomaly detection on data generated and/or stored in one or more data structures of the computer network/system;

FIG. 4A illustrates an example plot presenting relative entropy (RE) and account family size;

FIG. 4B illustrates an example plot presenting relative entropy (RE) and account family size after a Density-based Spatial Clustering of Applications with Noise (DBSCAN) algorithm is applied in accordance with the present disclosure, where the plot indicates anomalies and normal points;

FIG. 5A illustrates an example distribution of a normal case, without anomaly;

FIG. 5B illustrates an example distribution of anomalies detected via the via the DBSCAN algorithm; and

FIG. 6 illustrates output at an example dashboard based on detected anomalies and user input.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Transactions in payment networks may be segregated (or segmented) into two types: fraudulent and non-fraudulent. Based on these segments of prior transactions, machine learning (ML) systems (including algorithms associated therewith) may be employed to generate fraud models and/or rules (collectively referred to herein as fraud models) to generate scores for transactions in progress (broadly, future transactions), as indications of a likelihood that the transactions are (or, are not) fraudulent. In general, the fraud models, as generated by the ML systems, are built on the transaction data for the prior fraudulent and non-fraudulent transactions, whereby certain transaction data (e.g., transaction amounts, payment account types, transaction locations, card-present characteristics, merchants involved in the transactions, etc.) for the future transactions may be combined, via the fraud models, to provide the fraud scores for the future transactions.

In connection therewith, the fraud models may be employed generally, or specifically. For example, the fraud models may be employed for particular segments of payment accounts (e.g., where each payment account is associated with a payment account number (PAN) including a particular bank identification number (BIN), etc.), but not for other segments of the payment accounts. And, in so doing, from time to time, anomalies in the scores provided by the fraud models may exist due to problems (e.g., errors, etc.) in the ML systems (and algorithms associated therewith) and the models generated thereby. Due to the inherent nature of ML technology, such errors are difficult, if not impossible in some instances, to detect. This is particularly true since anomalies may not necessarily be the result of an error in the ML algorithms, but instead may be due to other factors such as, for example, a large scale fraud attack on the payment network.

Uniquely, the systems and methods herein permit detection of anomalies associated with the ML systems and/or fraud models generated thereby, which may be indicative of errors in the ML systems or, for example, large scale fraud attacks, etc. In particular, fraud scores are generated for one or more transaction in a target interval, and several prior intervals similar to the target interval. The fraud scores are generated as the transactions associated therewith are processed within the intervals. The fraud scores for the prior similar intervals, then, are compiled, by an engine, to provide a benchmark distribution. The engine then determines a divergence between the benchmark distribution and a distribution representative of the fraud scores for the target interval, per segment (or family) of the payment accounts (e.g., the BIN-based segments or families, etc.) involved in the transactions. The divergences between the distributions, per payment account segment, are then combined with a size of the segment of the distribution of the fraud score for the target interval, and clustered. The engine then relies on the clustering to designate one or more of the divergences as abnormal, whereby a user associated with the fraud model(s) is notified. In turn, the user(s) is permitted to investigate whether the divergence is the result of deployment errors associated with the fraud model(s) due to problems with the ML algorithms or other issues such as, for example, a large scale fraud attack on the payment network, etc. It should be appreciated that while the systems and methods herein solve problems attendant to AI, ML, and payment network security, the systems and methods may further have utility in detecting anomalies in one or more other technological applications.

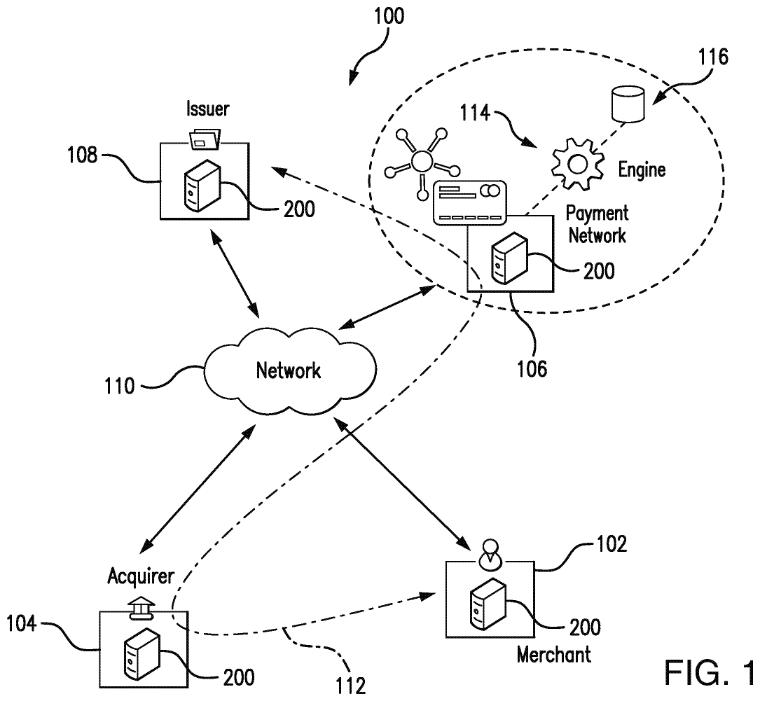

FIG. 1 illustrates an exemplary system 100, in which one or more aspects of the present disclosure may be implemented. Although the system 100 is presented in one arrangement, other embodiments may include systems arranged otherwise depending, for example, on types of transaction data in the systems, privacy requirements, etc.

As shown in FIG. 1, the system 100 generally includes a merchant 102, an acquirer 104, a payment network 106, and an issuer 108, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which may be accessible as desired to the merchant 102, the acquirer 104, etc.

The merchant 102 is generally associated with products (e.g., goods and/or services, etc.) for purchase by one or more consumers, for example, via payment accounts. The merchant 102 may include an online merchant, having a virtual location on the Internet (e.g., a website accessible through the network 110, etc.), or a virtual location provided through a web-based application, etc., that permits consumers to initiate transactions for products offered for sale by the merchant 102. In addition, or alternatively, the merchant 102 may include at least one brick-and-mortar location.

In connection with a purchase of a product by a consumer (not shown) at the merchant 102, via a payment account associated with the consumer, for example, an authorization request is generated at the merchant 102 and transmitted to the acquirer 104, consistent with path 112 in FIG. 1. The acquirer 104, in turn, as further indicated by path 112, communicates the authorization request to the issuer 108, through the payment network 106, such as, for example, through Mastercard®, VISA®, Discover®, American Express®, etc. (all, broadly payment networks), to determine (in conjunction with the issuer 108 that provided the payment account to the consumer) whether to approve the transaction (e.g., when the payment account is in good standing, when there is sufficient credit/funds, etc.).

In connection therewith, the payment network 106 and/or the issuer 108 includes one or more fraud models (as associated with one or more ML systems associated with the payment network 106 and/or the issuer 108, etc.). Each of the fraud models may be specific to a group (or family) of payment accounts (broadly, a payment account segment), for example, a payment account segment having primary account numbers (PANs) that share the same BIN (e.g., a first six digits of each of the PANs, etc.), whereby the payment account segment may be subject to the fraud model. When the payment network 106 and/or the issuer 108 receives the authorization request for the transaction, the payment network 106 and/or the issuer 108 may be configured to select one or more of the fraud models based on the group (or family) to which the payment account involved in the transaction belongs and, more particularly, based on the BIN included in the PAN for the payment account. The payment network 106 and/or issuer 108 is then configured to generate the fraud score based on the selected one or more fraud models, whereby the selected fraud model(s) used to generate the fraud score are specific to at least the payment account segment (or family) in which the payment account involved in the transaction belongs. That said, in one or more other embodiments, the one or more fraud models may be general to the payment network 106, the issuer 108, etc., such that the one or more fraud models are selected independent of the BIN included in the PAN.

In any case, the selected one or more fraud models rely on the details of the transaction as input to the model(s) (e.g., an amount of the transaction, a location of the transaction, a merchant type of the merchant 102, a merchant category code (MCC) for the merchant 102, a merchant name of the merchant 102, etc.). When the fraud score is generated by the payment network 106, the payment network 106 is configured to transmit the fraud score to the issuer 108 with the authorization request or in connection therewith. When the fraud score is generated by the issuer 108 (or the fraud score is received from the payment network 106), the issuer 108 is configured to use the fraud score, at least in part, in determining whether to approve the transaction, or not.

If the issuer 108 approves the transaction, a reply authorizing the transaction (e.g., an authorization reply, etc.), as is conventional, is provided back to the acquirer 104 and the merchant 102, thereby permitting the merchant 102 to complete the transaction. The transaction is later cleared and/or settled by and between the merchant 102 and the acquirer 104 (via an agreement between the merchant 102 and the acquirer 104), and by and between the acquirer 104 and the issuer 108 (via an agreement between the acquirer 104 and the issuer 108), through further communications therebetween. If the issuer 108 declines the transaction for any reason, a reply declining the transaction is provided back to the merchant 102, thereby permitting the merchant 102 to stop the transaction.

Similar transactions are generally repeated in the system 100, in one form or another, multiple times (e.g., hundreds, thousands, hundreds of thousands, millions, etc. of times) per day (e.g., depending on the particular payment network and/or payment account involved, etc.), and with the transactions involving numerous consumers, merchants, acquirers and issuers. In connection with the above example transaction (and such similar transactions), transaction data is generated, collected, and stored as part of the above exemplary interactions among the merchant 102, the acquirer 104, the payment network 106, the issuer 108, and the consumer. The transaction data represents at least a plurality of transactions, for example, authorized transactions, cleared transactions, attempted transactions, etc.

The transaction data, in this exemplary embodiment, generated by the transactions described herein, is stored at least by the payment network 106 (e.g., in data structure 116, in other data structures associated with the payment network 106, etc.). The transaction data includes, for example, payment instrument identifiers such as payment account numbers (or parts thereof, such as, for example, BINs), amounts of the transactions, merchant IDs, MCCs, fraud scores (i.e., indication of risk associated with the transaction), dates/times of the transactions, products purchased and related descriptions or identifiers, etc. It should be appreciated that more or less information related to transactions, as part of either authorization, clearing, and/or settling, may be included in transaction data and stored within the system 100, at the merchant 102, the acquirer 104, the payment network 106, and/or the issuer 108.

While one merchant 102, one acquirer 104, one payment network 106, and one issuer 108 are illustrated in the system 100 in FIG. 1, it should be appreciated that any number of these entities (and their associated components) may be included in the system 100, or may be included as a part of systems in other embodiments, consistent with the present disclosure.

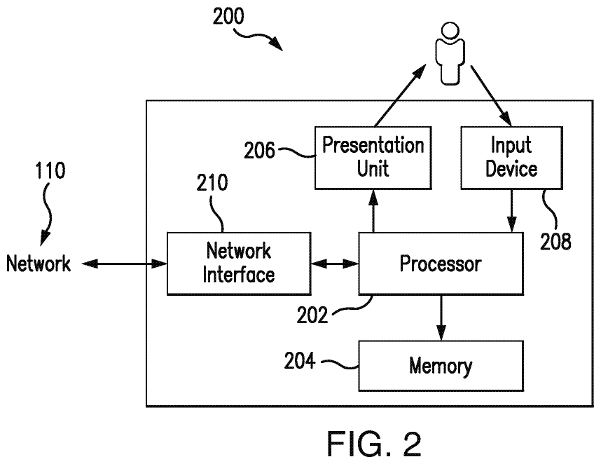

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the merchant 102, the acquirer 104, the payment network 106, and the issuer 108 are illustrated as including, or being implemented in or associated with, a computing device 200, coupled to the network 110. Further, the computing device 200 associated with each of these parts of the system 100, for example, may include a single computing device, or multiple computing devices located in close proximity or distributed over a geographic region, again so long as the computing devices are specifically configured to function as described herein.

Referring to FIG. 2, the exemplary computing device 200 includes a processor 202 and a memory 204 coupled to (and in communication with) the processor 202. The processor 202 may include one or more processing units (e.g., in a multi-core configuration, etc.) such as, and without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, a variety of data structures (including various types of data such as, for example, transaction data, other variables, etc.), fraud models, fraud scores, and/or other types of data (and/or data structures) referenced herein and/or suitable for use as described herein.

Furthermore, in various embodiments, computer-executable instructions may be stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 that is performing one or more of the various operations herein, whereby the instructions effectively transform the computing device 200 into a special purpose device configured to perform the unique and specific operations described herein. It should be appreciated that the memory 204 may include a variety of different memories, each implemented in one or more of the functions or processes described herein.

In the exemplary embodiment, the computing device 200 includes a presentation unit 206 that is coupled to (and in communication with) the processor 202 (however, it should be appreciated that the computing device 200 could include output devices other than the presentation unit 206, etc. in other embodiments). The presentation unit 206 outputs information, either visually or audibly to a user of the computing device 200, such as, for example, fraud warnings, etc. Various interfaces (e.g., as defined by network-based applications, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, another computing device, etc. In some embodiments, presentation unit 206 may include multiple devices.

The computing device 200 also includes an input device 208 that receives inputs from the user (i.e., user inputs). The input device 208 is coupled to (and is in communication with) the processor 202 and may include, for example, a keyboard, a pointing device, a mouse, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 may include the processor 202 and one or more network interfaces incorporated into or with the processor 202.

Referring again to FIG. 1, the system 100 includes an anomaly detection engine 114, which includes at least one processor (e.g., consistent with processor 202, etc.) specifically configured, by executable instructions, to perform one or more quality check operations on data and, in particular, the fraud scores, output by a given ML system, as described herein, whereby the anomaly detection engine 114 is specifically configured, in the illustrated embodiment, as an output tracer for the ML system, as describe herein.

As shown in FIG. 1, the engine 114 is illustrated as a standalone part of the system 100 but, as indicated by the dotted lines, may be incorporated with or associated with the payment network 106, as desired. Alternatively, in other embodiments, the engine 114 may be incorporated with other parts of the system 100 (e.g., the issuer 108, etc.). In general, the engine 114 may be implemented and/or located based on where, in path 112, for example, transaction data is stored, thereby providing access for the engine 114 to the transaction data, etc. In addition, the engine 114 may be implemented in the system 100 in a computing device consistent with computing device 200, or in other computing devices within the scope of the present disclosure. In various other embodiments, the engine 114 may be employed in systems at locations that allow for access to the transaction data, but that are uninvolved in the transaction(s) giving rise to the transaction data (e.g., at locations that are not involved in authorization, clearing, settlement of the transaction, etc.).

The system 100 also includes data structure 116 associated with the engine 114. The data structure 116 includes a variety of different data (as indicated above), including transaction data for a plurality of transactions, where the transaction data for each of the transactions includes at least one fraud score for the transaction generated by one or more fraud models (as associated with the ML system) selected for the transaction based on the BIN included in the PAN associated with the payment account involved in the transaction. In this manner, the fraud score(s) are generated consistent with the one or more fraud models.

Similar to the engine 114, the data structure 116 is illustrated in FIG. 1 as a standalone part of the system 100 (e.g., embodied in a computing device similar to computing device 200, etc.). However, in other embodiments, the data structure 116 may be included or integrated, in whole or in part, with the engine 114, as indicated by the dotted line therebetween. What's more, as indicated by the dotted circle in FIG. 1, the engine 114 and the data structure 116 may be included or integrated, in whole or in part, in the payment network 106.

With that said, the engine 114 is configured to detect anomalies in the fraud scores generated by the payment network 106 and/or issuer 108 using the ML given system. The engine 114 may be configured to automatically detect anomalies at one or more regular intervals, for example, at the end of every day (e.g., at 12:01 am every Monday, Tuesday, Wednesday, etc.) or at one or more predefined times (e.g., at 12:01 am each weekday and at 12:00 pm each weekend day, etc.). However, in one or more other embodiments, the engine 114 may be configured to detect anomalies on demand, in response to a request from a user associated with the engine 114, for example.

In any case, at the one or more intervals, predefined times, and/or in response to a request, the engine 114 is configured to initially access the prior fraud scores in the data structure 116, for use as described herein to detect anomalies in the prior fraud scores.

In connection therewith, the engine 114 is configured to access, from the data structure 116, fraud scores for a payment account segment for a target interval, as well as for a series of like intervals prior to the target interval for the same payment account segment. As should be appreciated from the above, the fraud scores are each associated with a transaction involving a payment account that is associated with a PAN including the same BIN (e.g., where the common BIN represents the accounts being in the same group family (e.g., a “platinum” account family, etc.). The prior intervals are similar to the target interval (broadly, prior like or similar intervals). The target interval may be a prior recent interval that has ended (e.g., a day that just ended, etc.). For example, where a current date and time is Friday August 16 at 12:01 a.m., and when the engine 114 is configured to detect anomalies in the fraud scores at the end of every day, the target interval may be the most recent Thursday August 15. The series of similar prior intervals, then, may include a prior ten Thursdays to the most recent Thursday August 15 (e.g., Thursday August 8; Thursday August 1; etc.). It should be appreciated that the fraud scores for the target interval and the fraud scores for the prior like intervals may be accessed concurrently, or at one or more different times.

In any case, after accessing the fraud scores for the prior like intervals, the engine 114 is configured to generate a baseline distribution (broadly, a benchmark or reference) based on the fraud scores for the accessed series of prior like intervals. As explained in more detail below, the engine 114 is configured to generate a baseline distribution that includes a value (e.g., an average score ratio, etc.) for each of multiple fraud score segments (or classes) (e.g., divisions of a fraud score range from 0-999, etc.).

For example, where the target interval is Thursday August 15, the benchmark may be generated based on fraud scores accessed for a series of prior like intervals that includes ten Thursdays prior to Thursday August 15 of the current year (e.g., the immediately prior consecutive ten Thursdays, etc.). The benchmark may be generated, using the fraud scores for the prior like intervals, in a variety of manners. With that said, due to the computational complexity of the benchmark generation, the engine 114 may be configured, in some embodiments, to use “day-of-week” interval (e.g., Thursdays, etc.) results in an improved scalability, while maintaining an interval of sufficient size to minimize the impact of noise, yet without including too much data such that latest trends cannot be reflected.

With that said, in connection with generating the benchmark in the example system 100, the engine 114 is configured to, for each prior like interval, map (broadly, segregate) the fraud scores into classes (broadly, fraud score segments (or divisions)) within the corresponding prior like interval, for example, using a class mapping table (broadly, a class segregation table) structured, for example, in accordance with Table 1 below. Each fraud score segment represents, or includes, a different division of the fraud score range. For example, where the one or more fraud models generated by the ML system are used to generate fraud scores in the range of 0-999 points, the fraud score segments (e.g., fraud score segment or class nos. 1-23, etc.) may include the ranges in Table 1.

TABLE 1

| Score Segment (or Class) | Score Range |
|---|---|
| 1 | 0 |
| 2 | 1 |
| 3 | 2-49 |
| 4 | 50-99 |
| 5 | 100-149 |
| 6 | 150-199 |
| 7 | 200-249 |
| 8 | 250-299 |
| 9 | 300-349 |
| 10 | 350-399 |
| 11 | 400-449 |
| 12 | 450-499 |
| 13 | 500-549 |
| 14 | 550-559 |
| 15 | 600-649 |
| 16 | 650-659 |
| 17 | 700-749 |
| 18 | 750-799 |
| 19 | 800-849 |
| 20 | 850-899 |
| 21 | 900-949 |
| 22 | 950-998 |
| 23 | 999 |

In the example system 100, the engine 114 is configured to, for each fraud score accessed, map (or segregate) the fraud score to the fraud score segment (or class) within the corresponding prior like interval into which the fraud score falls (e.g., an accessed fraud score of 39 for Thursday August 8 is mapped to fraud score segment no. 3 within the first prior like interval). And, for each fraud score segment, the engine 114 is configured to then count the number of fraud scores mapped thereto. For example, if the engine 114 maps 10,000 scores to the fraud score segment no. 14 for a particular prior like interval, the engine is configured to generate a count of 10,000 for the fraud score segment number 14 within that particular prior like interval. It should be appreciated that the engine 114 is configured to map and count the fraud scores separately for each prior like interval, such that the engine 114 generates distinct mappings and counts for each prior like interval (as opposed to merely collectively mapping all of the fraud scores across all prior like intervals to the score segments (or classes) and collectively counting the count of all fraud scores for all prior like intervals).

With the fraud scores for the prior like intervals mapped to the appropriate fraud score segments (on a prior like interval by prior like interval basis) and the number of scores mapped to each segment counted (again, on a prior like interval by prior like interval basis), the engine 114 is configured to generate a benchmark distribution for the prior like intervals based on the counts for the corresponding score segments (or classes) across the prior like intervals.

In connection therewith, in the example system 100, the engine 114 is configured to determine the total number of fraud scores mapped to the fraud score segments (e.g., class nos. 1-23, etc.) within each prior like interval (e.g., each of the prior ten Thursdays to a target Thursday, etc.) based on the counts. For example, where the target interval is Thursday August 15, the engine 114 may be configured to determine the total number of fraud scores collectively mapped to class nos. 1-23 for Thursday August 8, the total number of scores collectively mapped to class nos. 1-23 for Thursday August 1; etc. The engine 114 may then be configured, for each fraud score segment within each prior like interval, to calculate a score ratio by dividing the count for that fraud score segment by the total number of fraud scores collectively mapped to the prior like interval. For example, the target interval may be Thursday August 15 and the first prior like interval may be Thursday August 8. And, the total number of scores collectively mapped to class nos. 1-23 for Thursday August 8 may be 3,000,000. Further, the number of scores mapped to class no. 1 may be 30,000. In this example, the engine 114 then calculates a score ratio of 0.01 for class no. 1 for Thursday August 8 by dividing the count for class no. 1 (i.e., 30,000) by the total number or scores mapped to class nos. 1-23 for Thursday August 8 (i.e., 3,000,000). The engine 114 is similarly configured to calculate a score ratio for each other fraud score segment (or class) for Thursday August 8, as well as each other fraud score segment (or class) within the other prior like intervals (e.g., each of class nos. 2-23 within the Thursday August 8 interval, each of class nos. 1-23 within the Thursday August 1 interval; etc.).

With the score ratios calculated for each fraud score segment (or class) within each prior like interval, the engine 114 is configured to average the score ratios for the corresponding fraud score segments (or classes) across the prior like intervals, thereby generating an average score ratio for each of the multiple fraud score segments. For instance, continuing with the above example, the engine 114 is configured to sum the score ratios for class no. 1 for each of the prior ten Thursdays (i.e., Thursday August 8, Thursday August 1, etc.) and divide the sum by ten, to calculate the average score ratio for fraud score segment (or class) no. 1. The engine 114 is similarly configured for each of fraud score segments (or classes) nos. 2-23 within the corresponding prior like intervals. The engine 114 is then configured to define the benchmark distribution as the set of the average score ratios (i.e., the set of 23 average score ratios in this example).

With that said, in one or more other embodiments, the engine 114 may be configured to generate the benchmark distribution in one or more other manners, such as by taking the time-decay weighted average of the counts for each corresponding score segment (or class) across the prior like intervals In either case, the benchmark distribution of the fraud scores for the prior like intervals serves to define what is “normal.”

As explained above, the engine 114 is also configured to access the fraud scores for the target interval (e.g. Thursday August 16 of the current year, etc.) from the data structure 116. The engine 114 is configured to then map (or segregate) each fraud score for the target interval into the fraud score segment (or class) into which the fraud score falls, similar to the above for the prior like intervals, and again using a class mapping (or class segregation) table structured in accordance with Table 1 above. For each fraud score segment, the engine 114 is then configured to count the number of fraud scores within the target interval assigned to the fraud score segment, again in a similar manner to the above for the prior like intervals. It should also be appreciated that the engine 114 is configured to map (or segregate) and count the fraud scores for the target interval separately from the mapping and counting of the fraud scores for the prior like intervals.

Based on the counts, the engine 114 is configured to count the total number of fraud scores mapped to the fraud score segments (e.g., class nos. 1-23) within the target interval, based on the counts. The engine 114 is then configured, for each fraud score segment within the target interval, to calculate a score ratio by dividing the count for that fraud score segment by the total number of fraud scores collectively mapped to the target interval, also in a similar manner to the table for the like prior intervals (except there is no averaging in this example since there is only one target interval). The engine 114 is then configured to define the set of score ratios for the target interval as the current distribution, which serves to provide a “current” distribution of the fraud scores.

With the fraud scores for the target interval mapped and counted, the benchmark distribution generated for the prior like intervals, and the current distribution generated for the target interval, the engine 114 is configured to then determine a Kullback-Leibler (KL) divergence for the fraud scores mapped and counted for the target interval and for the baseline (or benchmark) distribution generated for the prior like intervals (again, where the benchmark distribution is defined across the corresponding fraud score segments across the prior like intervals). The KL divergence provides a number indicative of the divergence (or relative entropy (RE)), per fraud score segment (or class), between the benchmark distribution for the prior like intervals and the current distribution for the target interval.

In the example system 100, the engine 114 is configured to determine the KL divergence, D(p∥q), based on Equation (1). In Equation (1), q(x) is the benchmark distribution for the prior like intervals and p(x) is the current distribution (e.g., calculated at the end of each day (e.g., at 12:01 a.m. on a Friday for prior the Thursday, etc.), etc.) for the target interval, whereby the KL divergence is based on the benchmark distribution and the current distribution.

$$D ( p \vert \vert q ) = \sum p ( x ) ln ( \frac{p ( x )}{q ( x )} ) dx \qquad ( 1 )$$

It should be appreciated that in one or more other embodiments, the engine 114 may be configured to determine the KL divergence based on one or more other equations, such as, for example, Equation (2), where Q(i) is the benchmark distribution for the prior like intervals and P(i) is the “current” distribution for the target interval.

$${D}_{KL} ( P \vert \vert Q ) = - {\sum }_{i} P ( i ) log ( \frac{Q ( i )}{P ( i )} ) \qquad ( 2 )$$

It is noted that, unlike squared Hellinger distance expressions, KL divergence is not restricted between zero and 1. With KL divergence, a sizeable distribution change may be translated to a change of larger magnitude, which facilitates the creation of a threshold which may be utilized to directly influence the performance of an ML system or model (e.g., a fraud scoring model, etc.). As such, a well-chosen threshold (e.g., based on KL divergence, etc.) may significantly improve performance of an ML system or model. Further, in one or more other embodiments, the engine 114 may be configured to determine both D(p∥q) and D (q∥p) and average D(p∥q) and D (q∥p) in accordance with Equation (1) (where, for D(q∥p), p(x) and q(x) are essentially flipped) (with a small positive number replacing all zero probability densities).

What's more, the engine 114 may be configured to generate the benchmark distribution, the current distribution for the target interval, and, thus, the KL divergence, on a BIN-by-BIN basis (or payment account segment by payment account segment basis). As explained above, the engine 114 initially accesses, from the data structure 116, fraud scores for a target interval and for a series of like intervals prior to the target interval, where the fraud scores are each associated with a transaction involving a payment account associated with a PAN including a common BIN. In turn, the engine 114 may be configured to proceed to generate the KL divergence based on the fraud scores, which is then BIN-specific. The engine 114 may be configured to thereafter (or concurrently) access, from the data structure 116, other fraud scores for the target interval and for the series of prior like intervals, where the fraud scores are each associated with a payment account that is associated with a PAN including a different, common BIN, where the engine 114 is configured to then proceed to generate a KL divergence based on these two BIN-specific (or payment account segment-specific) fraud scores. This may continue for any number of different BINs (or payment account segments), or even all of the different BINs (or payment account segments) associated with the payment network 106 and/or issuer 108.

It should be appreciated that payment account segments (or families) that have fewer observations (e.g., fewer transactions for which fraud scores are generated, etc.) tend to have more volatile fraud score segment (or class) distributions, which may lead to higher relative entropy (RE) values. Thus, in one or more embodiments, the engine 114 is configured to generate a second factor (in addition to the KL divergence) to detect such anomalies. In connection therewith, the engine 114 is further configured to determine a “size” (also referred to as “activeness”) of each of the multiple payment account segments (or families) (each associated with a different BIN). In this exemplary embodiment, the engine 114 is configured to calculate the size (or activeness) as the natural log (or, potentially, base 10 log) of the average number of total active transactions under a specific BIN (or even a group of BINs) for one or more fraud models for each of the past ten prior like intervals (e.g., the past ten same days-of-weeks, etc.) (which may be consistent with the prior like intervals discussed above). In other examples, the engine 114 may be configured to calculate the size of a BIN (or account family, etc.) as the natural logarithm (or, potentially, base 10 log) of an average number of transactions (or activities) performed under the BIN (e.g., daily, weekly, etc.) over a particular period (e.g., over the past 10-week period, etc.). It should be appreciated that fraud scores (or the counts thereof) are not taken into account for the activeness factor. With that said, it should be appreciated that the size may be calculated or otherwise determined by the engine 114 in other manners in other embodiments. Regardless, for each of the multiple payment account segments, the engine 114 is configured to combine the divergence and the size, to form a divergence pair for which a KL divergence was generated by the engine 114.

Again, it should be appreciated that the payment account to which the transactions are directed may be segmented, for example, by account type (e.g., gold card, platinum card, etc.), by issuers (e.g., issuer 108, different issuers, etc.), by location, or by combinations thereof, etc. And, the engine 114 may be further configured to repeat the above operations for each of the payment account segments. In general, however, the payment accounts may be segmented in any manner, whereby the benchmark for the prior like intervals, the KL divergence, the activeness, and thus, the divergence pair, are determined for transactions exposed to one or more consistent fraud models (e.g., the same fraud model(s), etc.).

With the divergence pairs generated/determined for each payment account segment (or account family), the engine 114 is configured to next cluster the divergence pairs for each of the payment account segments and the fraud model(s) associated therewith. In this exemplary embodiment, the engine 114 is configured to apply an unsupervised learning model to the divergence pairs and, in the example system 100, a Density-based Spatial Clustering of Applications with Noise (DBSCAN) algorithm (or model), to the multiple divergence pairs. The DBSCAN model may yield benefits over other models, such as isolation forest algorithms, due to the non-linear nature of the RE values versus natural logarithm of the account family size/activeness and the anomalies versus normal points (which are discussed in more detail below).

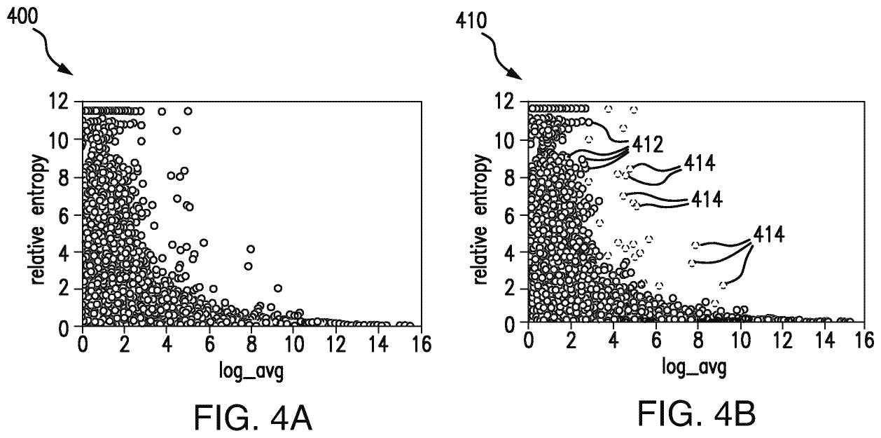

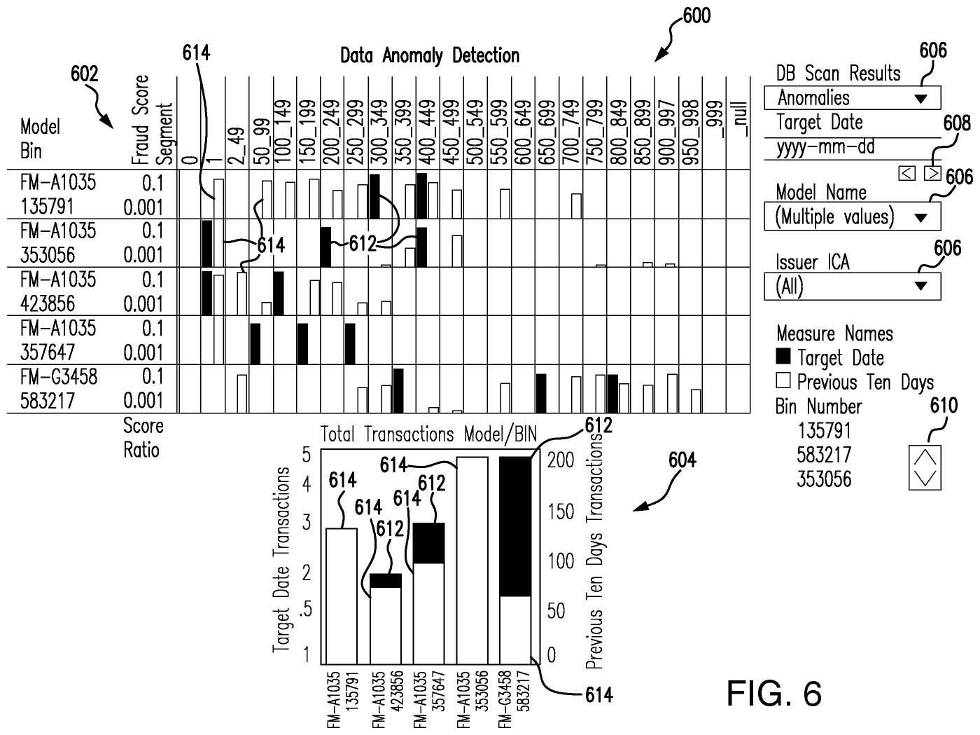

The engine 114 is configured to then output, by way of the DBSCAN model, the divergence pairs assigned to clusters, where the largest cluster (and divergence pairs assigned thereto) is defined (or designated) as normal (or, as normal points) with the one or more other clusters (and divergence pairs assigned thereto) defined (or designated) as abnormal (or as anomalies) (where the normal points are in high density regions and the abnormal points are in low density regions), as conceptually illustrated in FIG. 4B. In this manner, the engine 114 is configured to designate one or more of the multiple divergence pairs as abnormal based on the clustered divergence pairs, whereby the engine 114 is then permitted to generate a dashboard (e.g., dashboard 600 in FIG. 6, etc.) (e.g., including one or more interfaces visualizing anomalous behavior of the one or more fraud score models, as discussed in more detail below, etc.).

For exemplary purposes, FIG. 4A illustrates an example plot 400 presenting relative entropy (RE) and account family size (or activeness). In particular, the plot of FIG. 4A presents RE values against the natural log of payment account segment (or account family) sizes, which are derived from the output of the ML system. As can be appreciated, the plot shows a dense cluster with comparatively few scattered points. This illustrates the difficulty, if not the impossibly, of having to manually mine data produced by the ML system in attempt to identify anomalies, which, as in FIG. 4A, may be few and far between (e.g., before a smaller issue grows to more clearly manifest itself, at which point it may be difficult, if not impossible, to correct (e.g., in the case of a large scale fraud attack or where a fraud model generated by the ML system has tainted large swaths of data, etc.), etc.).

Also for exemplary purposes, FIG. 4B illustrates an example plot 410 presenting relative entropy (RE) and account family size after the DBSCAN algorithm is applied by the engine 114 (as described herein), where the plot indicates anomalies and normal points. Based on the engine's application of the DBSCAN algorithm in accordance with the above, the data is “labeled” by the DBSCAN algorithm, showing a large normal cluster by solid outline circles 412 (with the cluster of solid outline circles indicating inliers), and a cluster identifying anomalies by dashed outline circles 414 (with the dashed outline circles indicating outliers), where the anomalies/outliers are captured by the DBSCAN algorithm.

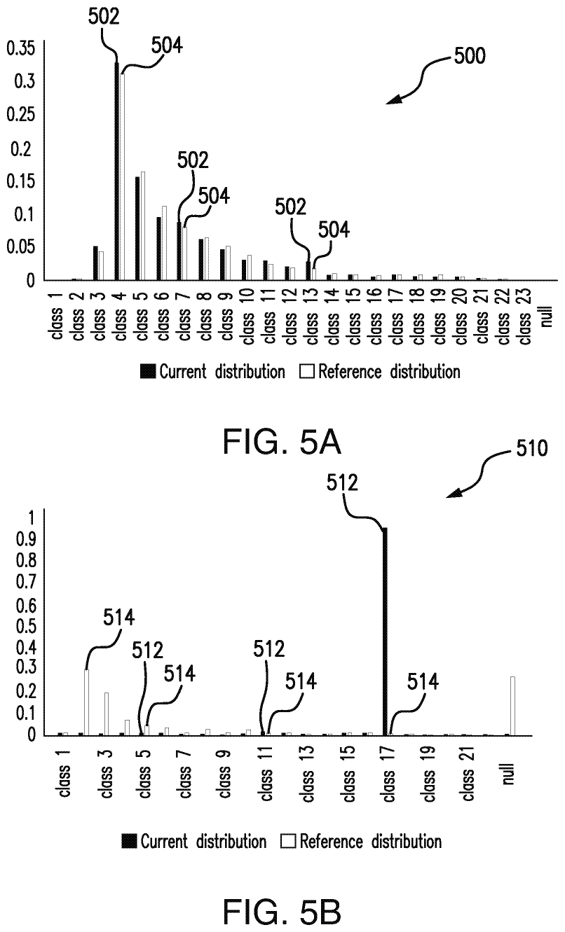

Also for exemplary purposes, FIG. 5A includes a bar graph 500 illustrating an example distribution of a normal case, without anomaly (e.g., the cluster points in FIG. 4B illustrated with a solid outline circle, etc.). The bars 502 represent a current (or target) interval, while the bars 504 represent a reference (or benchmark) distribution. FIG. 5B then includes a bar graph 510 illustrating an example of the distribution of the anomalies detected by the engine 114 via the DBSCAN algorithm (e.g., the dashed outline cluster points 414 in FIG. 4B, etc.). The x-axes of FIGS. 5A and 5B represent the applicable fraud score segments (or classes) (where FIG. 5B includes labels for every other fraud score segment). The y-axes of FIGS. 5A and 5B represent the average score ratio (on a scale from zero to one) for the corresponding fraud score segments (or classes) across the like prior intervals for the reference (or benchmark) distribution and for the current (or target) interval. In particular, as can be appreciated, the illustration in FIG. 5B visualizes how the current (or target) distribution, as represented by the bars 512, is significantly different from its reference distribution (or benchmark), as represented by the bars 514. This is particularly so, for example, in the case of class nos. 2, 3, 4, and 17, as well as for null transactions. In this example, null transactions are transactions for which no fraud scores were generated or attached, which are indicators of potential model misbehavior.

In any event, with continued reference to the example system 100, the engine 114 is configured to generate a dashboard (broadly, an interface) (e.g., a Tableau interactive dashboard, etc.) based on the output of the DBSCAN algorithm and, in particular, the anomalies identified by the DBSCAN algorithm, as well as one or more user inputs (e.g., filter selections, target date selections, payment account segment (or family) selections (e.g., BIN selections, etc.), etc.), and to transmit the dashboard to a user (e.g., a fraud analyst, etc.) (e.g., to a computing device 200 of the user (e.g., via a web-based application, etc.), etc.). The user may then manually investigate the abnormal pair, which may indicate an anomaly in fraudulent transactions (e.g., an increase in fraud activity, etc.), or an error in the fraud model(s) contributing to the generation of the fraud scores.

It should be appreciated that in one or more embodiments, the engine 114 may be configured to apply one or more business rules, which configure the engine 114 to either automatically identify a divergence pair for a payment account segment as abnormal or to ignore an abnormal divergence pair for a payment account segment (e.g., where the size of the pair is less than a threshold, while the divergence is above a threshold, etc.), etc. For example, the engine 114 may be configured to apply a business rule that ignores divergence pair anomalies where the size (or activeness) of the payment account segment is less than two. In such embodiments, the engine 114 may be configured to then generate the dashboard while ignoring the divergence pair anomalies that do not satisfy any applied business rule(s).

FIG. 6 illustrates an example dashboard 600, which the engine 114 may be configured to generate based on the anomalies (i.e., the clustered divergence pairs designed as abnormal) identified by the DBSCAN algorithm and user input (e.g., from FIG. 5B, etc.). In connection therewith, the dashboard 600 includes at least two segments. The first segment includes an interface 602 (e.g., a graphical user interface (GUI), etc.) that identifies detected anomalies by fraud score segment (or class) based on a user's selection of a target date (or interval) (e.g., 20XX-04-05 (a Friday), etc.), one or more fraud model names (e.g., FM-A1035 and FM-G3458, etc.), and one or more issuer control association (ICA) numbers (e.g., all ICAs associated with the payment network 106, etc.), which are each associated with one or more BINs (or payment account segments (or families)) (e.g., ICAs associated with BINs 135791, 353056, 932856, 557647, and 583217, etc.). In the example interface 602, the option to display detected anomalies, the fraud model name(s), and the ICA number(s) are selectable via drop downs 606. And, the target date is adjustable via slider bar 608. The BIN numbers associated with the selected ICA numbers are displayed in scrollable form at 610. As such, it should be appreciated that the dashboard 600 includes a number of filters to limit the data displayed by the dashboard 600, thereby allowing the user to view particular data in which he or she is interested.

In connection therewith, the anomaly detection interface 602 displays anomalies detected or identified by the DBSCAN algorithm, as filtered based on user input, in the form of a bar graph. The shaded bars 612 represent the target date (or interval), and the bars 614 (having no fill) represent the ten days prior to the target date (or the prior like intervals (e.g., the ten Fridays prior to 20XX-04-05, etc.). As shown in interface 602, the bar graph visualizes, for each fraud score segment (e.g., each of fraud score segments 0-23, as well as null transactions; etc.), the difference between the average score ratio across the previous ten days (or prior like intervals) and the score ratio for the target date (or target interval) where anomalies were found to exist by the DBSCAN algorithm. Data for non-anomalous (or normal) score ratios is suppressed in the bar graph, to allow the user to focus on data of potential concern. For example, based on the interface 602 as generated, and based on the example input explained above, the user is permitted to readily discern that there is anomalous behavior involving an appreciable uptick in fraud scores falling within fraud score segments 250-399 and 650-699 for the target date (as compared to the previous ten days) for BIN 583217 as associated with fraud score model FM-G3458. Based on the observation permitted by the interface 602, the user may then direct resources to investigate (and potentially correct) the fraud score model FM-G3458 and/or the ML system that generated the same.

The second segment includes an interface 604 for monitoring, for each fraud score model and BIN associated with the selected ICA(s), the total number of transactions under the BIN (or payment account segment (or family)) for the target date against the total number of transactions under the BIN for the previous ten days (or prior like intervals). In particular, for each fraud score model and BIN for which anomalies were detected (as reported in interface 602), the shaded bars 612 (or portions thereof) represent the number of transactions (e.g., on a scale set by the payment network 106 or issuer 108 (e.g., 1000s, 10,000s, 1,000,000s, etc.), etc.) for the BIN on the target date (as indicated on the left y-axis), and the bars 614 (or portions thereof) (having no fill) represent the number of transactions to the BIN during the previous ten days (as indicated on the right y-axis).

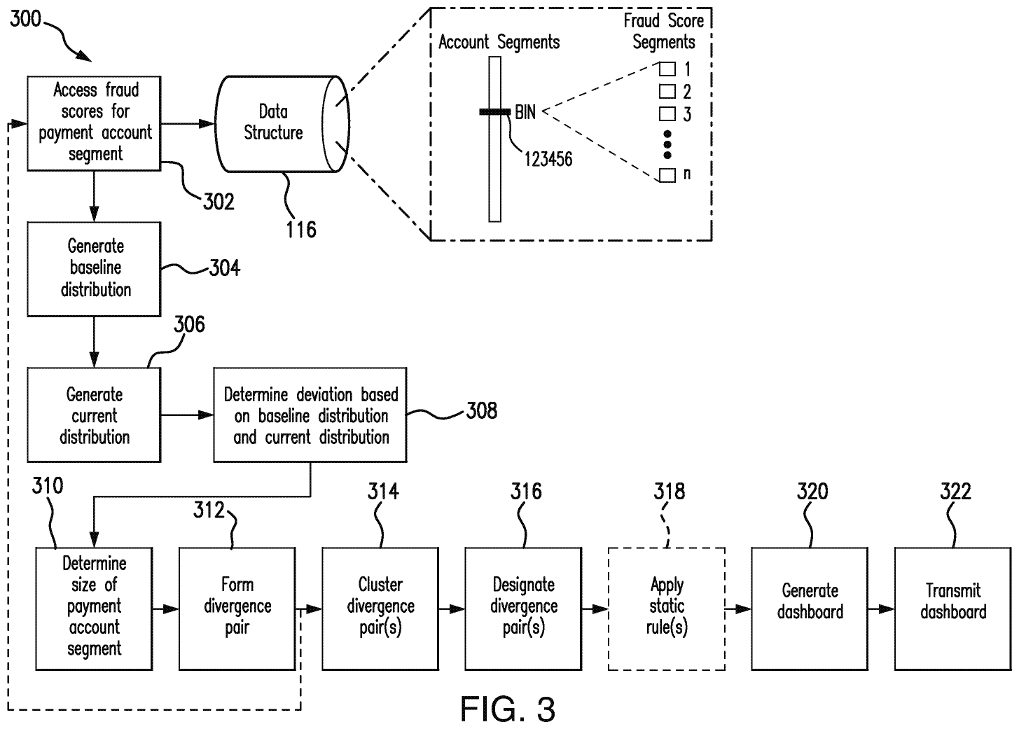

FIG. 3 illustrates an exemplary method 300 for performing anomaly detection on data generated and/or stored in data structures. The exemplary method 300 is described as implemented in the system 100 and, in particular, in the engine 114. However, it should be understood that the method 300 is not limited to the above-described configuration of the engine 114, and that the method 300 may be implemented in other ones of the computing devices 200 in system 100, or in multiple other computing devices. As such, the methods herein should not be understood to be limited to the exemplary system 100 or the exemplary computing device 200, and likewise, the systems and the computing devices herein should not be understood to be limited to the exemplary method 300.

In the method 300, the data structure 116 includes transaction data, consistent with the above, for a plurality of transactions processed by the payment network 106 for the last year, and/or for other intervals. Also consistent with the above, the transaction data for each transaction includes fraud score data (and, in particular, a fraud score), where each of the fraud scores is associated with a BIN for the payment account included in the underlying transaction. The BIN includes a first six digits of a PAN associated with the payment account. In addition to a particular issuer, a BIN may further identify payment accounts by type or family (e.g., gold accounts, silver accounts, platinum accounts, etc.). As such, it should be appreciated that the fraud scores may be segregated by the BIN into payment account segments. That said, it should be appreciated that the fraud scores, included in the data structure 116, may be associated with additional or other data by which the fraud scores may be segregated for comparison.

As shown in FIG. 3, the engine 114 initially accesses the data structure 116, at 302, and specifically accesses the fraud scores in the transaction data for the plurality of transactions in the data structure 116 for a target interval, for a given payment account segment and for a series of like intervals prior to the target interval for the given payment account segment (e.g., as defined by an applied fraud model and/or BIN, etc.). As illustrated in FIG. 3, for a given set of payment accounts, the payment accounts may be segregated in the data structure 116, based on the BINs associated therewith.

In this example, the anomaly detection is, at least initially, performed for payment accounts associated with a target BIN 123456 (e.g., in response to a selection by a user of the BIN 123456 as the target BIN via the dashboard 600, etc.). The target interval is Thursday, September 27 (e.g., as also specified by the user via the dashboard 600, etc.). And, the similar prior intervals include the same day of the week, i.e., Thursday, and the series includes the last 10 Thursdays. As such, the engine 114 accesses fraud scores (from the data structure 116) for payment accounts having the BIN 123456 within the target interval and for each prior like interval. It should be appreciated, however, that a different series and/or similar interval may be selected in one or more different embodiments.

Consistent with the above explanation, after accessing the fraud scores at 302, the engine 114 generates a baseline distribution (broadly, a benchmark or reference) at 304, based on the fraud scores for the accessed series of prior like intervals. In connection with generating the benchmark in the example method 300, the engine 114, for each prior like interval, maps (broadly, segregates) the fraud scores within the prior like interval into classes (broadly, fraud score segments), for example, in accordance with the class segmentation table shown in Table 1 above. And, for each fraud score segment, the engine 114 counts the number of fraud scores mapped thereto. With the fraud scores for the prior like intervals mapped to the appropriate fraud score segments (on a prior like interval by prior like interval basis) and the number of scores mapped to each segment counted (again, on a prior like interval by prior like interval basis), the engine 114 generates the benchmark distribution for the prior like intervals based on the counts for the corresponding score segments (or classes) across the prior like intervals.

In connection with generating the baseline distribution at 304, the engine 114 determines the total number of fraud scores mapped to the fraud score segments (e.g., class nos. 1-23, etc.) within each prior like interval (e.g., each of the prior ten Thursdays to a target Thursday, etc.) based on the counts, consistent with the above explanation in relation to the system 100. The engine 114 then, for each fraud score segment within each prior like interval, calculates a score ratio by dividing the count for that fraud score segment by the total number of fraud scores collectively mapped to the prior like interval, consistent with the above explanation for system 100.

With the score ratios calculated for each fraud score segment (or class) within each prior like interval, the engine 114 averages the score ratios for the corresponding fraud score segments (or classes) across the prior like intervals. The engine 114 then defines the benchmark distribution as the set of the average score ratios (i.e., the set of 23 average score ratios in this example), consistent with the above explanation in relation to system 100. Again, the benchmark fraud scores may be determined in a variety of manners. In this example, the engine 114, for each prior like interval, maps (or segregates) the fraud scores, by value, into multiple fraud score segments (or classes or divisions) ranging from 1 to n (as shown in FIG. 3). Because the fraud scores are defined by values in the range from 0 to 999 in this example (i.e., where the values indicate a risk associated with the transaction), the fraud scores are divided into different segments defined by ranges within the 0-999 range. As indicated above, the fraud score segments (or classes) may, for example, be consistent with those shown in Table 1, which provides twenty-three divisions of the range (or fraud score segments or classes) (i.e., n=23). However, it should be appreciated that the distribution may be defined by a different number of divisions (e.g., five, ten, fifteen, one hundred, or another number of divisions, etc.) as desired. But, in any case, the benchmark distribution of the fraud scores for the prior like intervals serves to define what is “normal.”

With continued reference to FIG. 3, at 306, the engine 114 generates a current distribution of fraud scores for the target interval. In connection therewith, the engine 1114 maps (or segregates) each fraud score for the target interval into the fraud score segment (or class) into which the fraud score falls and, for each fraud score segment, counts the number of fraud scores within the fraud score segment, similar to the above explanation in relation to system 100. Specifically, the engine 114 divides the accessed fraud scores for the target interval into fraud score segments (or classes) 1 to n, i.e., into the twenty-three intervals described above for the above example (as done for the fraud scores for the prior like intervals in determining the benchmark fraud scores), again consistent with the explanation above. The engine 114 then counts of the fraud scores, per fraud score segment.

The engine 114 counts the total number of fraud scores mapped to the fraud score segments (e.g., class nos. 1-23) within the target interval, similar to the above for the prior like intervals. The engine 114 is then configured, for each fraud score segment within the target interval, to calculate a score ratio by diving the count for that fraud score segment by the total number of fraud scores collectively mapped to the target interval, also in a similar manner to the table for the like prior intervals (except there is no averaging in this example since there is only one target interval). The engine 114 is then configured to define the set of score ratios for the target interval as the current distribution, which serves to provide a “current” distribution of the fraud scores.

The engine 114 next determines, at 308, a deviation (or divergence) between the fraud scores for the prior like intervals and the fraud scores for the target interval based on the current distribution for the target interval and the benchmark distribution for the prior like intervals. While the engine 114 may employ any of a variety of comparison algorithms, the engine 114, in this example, determines a deviation between the fraud scores for the target interval (be it for averages or counts, per segment and/or per fraud model) and the benchmark fraud, through KL divergence, consistent with the explanation above in the system 100. In short, the KL divergence is a statistical technique that measures the difference between the first (or current) distribution (i.e., a series of score ratios, per segment, for the target interval) and the second (or benchmark) distribution (i.e., a series of averages of the score ratios, per segment, for the prior like intervals). This is further identified, by those skilled in the art, as a relative entropy (RE) of the distributions. Without limitation, two exemplary expressions of the KL divergence, either of which may be used herein, are provided above as Equations (1) and (2) (for the current distribution p or P and benchmark distribution q or Q).

With the divergence technique described above, for the multiple fraud score segments, the engine 114 determines a divergence value for the BIN 123456, in this example (and a particular fraud model associated with at least the BIN 123456). For the divergence value, the engine 114 then determines, at 310, a size (also referred to as “activeness”) of the given payment account segment (or family) (for which fraud scores were accessed at 302). In the example method 300, the engine 114 calculates the size (or activeness) as the natural log (or potentially, base 10 log) of the average number of total active transactions under the given BIN (or even a group of BINs) for one or more fraud models over the prior like intervals (e.g., the past 10 Thursdays, etc.), consistent with the above explanation in relation to system 100. When the size of the BIN 123456 (representing a particular payment account segment (or family) is determined, the engine 114 combines the size with the divergence value for the BIN, at 312, to form a divergence pair for the given BIN.

While the description above is related to only one BIN, it should be appreciated that the above may be repeated for one or more additional BINs (or the payment account segments (or families) of interest) in further aspects of the method 300, or for other divisions of the accounts, to thereby provide additional divergence pairs for the one or more additional BINs (or the further divisions of the accounts) to be combined with the divergence pairs for the BIN 123456. That said, in general, only those divergences that are based on fraud scores generated by the same fraud model(s) will be combined for the remaining aspects of method 300, for example, to rely on the consistency of the fraud scores generated by the same fraud model(s). As such, in one example, a BIN or other segment may be sub-divided into different segments as defined by, for example, fraud models applied to the different divisions within the BIN. That said, in at least one embodiment, fraud scores from multiple different fraud model(s) (or the same and different fraud model(s)) may be combined and subjected to the further aspects of method 300.

With continued reference to FIG. 3, the engine 114 next clusters the divergence pairs for the target interval for a series of BINs (i.e., BIN 123456 and one or more other BINs) (or more broadly, for multiple payment account segments (or families)), at 314, consistent with the explanation above in relation to system 100. The clustering, in this exemplary embodiment, is again based on DBSCAN, which (as generally described above) is an unsupervised learning algorithm. The output from the clustering generally will include one or more clusters of closely packed divergence pairs. The cluster having the most divergence pairs (or highest number of divergence pairs) included therein (e.g., a majority cluster, etc.) is determined, by the engine 114, to be “normal” or “good” divergence points/pairs, while the other clusters and/or other divergence pairs are designated, by the engine 114, at 316, as one or more abnormal pairs, consistent with the above explanation in relation to system 100.

It should be appreciated that in one or more variations of method 300, the engine 114 may optionally apply, at 318, one or more generic (or static) rules (e.g., business rules, etc.) to the designations provided at 316, before proceeding to 320. The rules are generic in that the rule(s) are applied regardless of the BIN, fraud model, and/or the target interval. An exemplary generic rule may include designating a pair as abnormal (regardless of the clustering) when the divergence value is above a certain threshold. Other generic rules may be compiled based on the size (or activeness) of the BIN, the divergence, or other aspects of the fraud score or underlying transactions. For example, a rule may include de-designating an abnormal pair (e.g., designating an abnormal pair as normal or good, etc.), when the size (or activeness) of the BIN is less than a certain threshold (e.g., 2, etc.). This particular rule may be imposed to avoid presenting data to users (e.g., via the dashboard 600, etc.) where only a minor number of accounts are impacted and/or a relatively small number of transactions form the basis for the designation.

Once the designation is completed, and the generic rules (optionally) applied, the engine 114 then generates, at 320, a dashboard consistent with the example dashboard 600 illustrated in FIG. 6 and explained above. The engine 114 then transmits, at 322, the dashboard to one or more users associated with the fraud models and/or other users of the abnormal pairs, the BIN(s) involved, and/or the fraud model rules associated therewith. The user(s) may then notify one or more other users and/or investigate a potential fraud condition resulting in the unexpected divergence (e.g., large scale fraud attacks, etc.) and/or issues with the associated fraud model(s) resulting in the unexpected divergence (e.g., fraud model(s) generated or deployed by the ML system incorrectly, etc.). It should be appreciated that the user(s) may proceed otherwise, as indicated by the specific divergence values and/or observations made from the dashboard.

In view of the above, the systems and methods herein provide for improved anomaly detection and/or anomaly detection for fraud models generated by ML systems, where none previously existed. When such fraud models are deployed, especially in an enterprise solution, monitoring of the fraud models and performance related thereto may be limited. While fraud model performance may be assessed through the manual review of fraudulent determinations and/or flagging by the fraud models, such manual review may be impractical and/or unsuited to enterprise implementation of fraud models, where hundreds of thousands and/or millions of fraud scores are generated on a daily or weekly basis. In connection therewith, mis-performing fraud models (e.g., based on improper deployment, etc.) can cause the unnecessary rejection of hundreds or thousands or tens of thousands of transactions, thereby providing substantial losses to payment networks, issuers, and/or others associated with the transactions (e.g., consumers may become unwilling to use overly restrictive payment accounts, which then, again, impacts the payment network and/or issuer; etc.).

What's more, timely response to operational issues or incidents (e.g., broken fraud models generated by the ML system, large scale fraud attacks, etc.) is critical because relevant teams are often unaware of misbehaviors of a ML system or fraud attacks until the impact becomes very large. The systems and methods herein ensure the ML systems and/or enterprise networks function in the expected way, whereby technicians may be timely alerted to potential fraud score misclassifications (or potential attacks) on the payment network, but also allowing the anomalies/issues to be located immediately.

That said, the systems and methods herein provide an automated solution that provides an improved measure of the performance of fraud models over time, where divergence is employed to detect a problem, and then, manual review is employed later to investigate the problem. Importantly, manual review is not first used to detect the problem, whereby an automated performance assessment solution for enterprise deployment of fraud models is instead employed, as described herein.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) accessing fraud scores for a segment of payment accounts for a target interval and for a series of prior similar intervals, the segment of payment accounts subject to at least one fraud model whereby the fraud scores are generated consistent with the at least one fraud model; (b) generating, by a computing device, a baseline distribution based on the fraud scores for the segment of payment accounts for the series of prior similar intervals, the baseline distribution including a value for each of multiple fraud score segments across a range; (b) generating, by the computing device, a current distribution based on the fraud scores for the segment of payment accounts for the target interval, the current distribution including a value for each of the multiple fraud score segments; (c) determining, by the computing device, a divergence value between the baseline distribution and the current distribution for the segment of payment accounts; (d) determining, by the computing device, an activeness of the segment of payment accounts based on a total number of transactions involving the payment accounts for each of the prior similar intervals, whereby the divergence value and the activeness form a divergence pair; repeating steps (a) to (d) for one or more other segments of payment accounts, whereby multiple divergence pairs are determined for multiple segments of payment accounts; clustering, by the computing device, the multiple divergence pairs for the multiple segments of payment accounts; and designating, by the computing device, one or more of the multiple divergence pairs as abnormal based on the clustered divergence pairs, thereby permitting generation of an interface visualizing anomalous behavior of the at least one fraud score model.

Exemplary embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in detecting anomalies in output of a fraud score model generated by a machine learning system, the method comprising:
(a) accessing fraud scores for a segment of payment accounts for a target interval and for a series of prior similar intervals, the segment of payment accounts subject to at least one fraud model whereby the fraud scores are generated consistent with the at least one fraud model;
(b) generating, by a computing device, a baseline distribution based on the fraud scores for the segment of payment accounts for the series of prior similar intervals, the baseline distribution including a value for each of multiple fraud score segments across a range;
(b) generating, by the computing device, a current distribution based on the fraud scores for the segment of payment accounts for the target interval, the current distribution including a value for each of the multiple fraud score segments;
(c) determining, by the computing device, a divergence value between the baseline distribution and the current distribution for the segment of payment accounts;
(d) determining, by the computing device, an activeness of the segment of payment accounts based on a total number of transactions involving the payment accounts for each of the prior similar intervals, whereby the divergence value and the activeness form a divergence pair;
repeating steps (a) to (d) for one or more other segments of payment accounts, whereby multiple divergence pairs are determined for multiple segments of payment accounts;
clustering, by the computing device, the multiple divergence pairs for the multiple segments of payment accounts; and
designating, by the computing device, one or more of the multiple divergence pairs as abnormal based on the clustered divergence pairs, thereby permitting generation of an interface visualizing anomalous behavior of the at least one fraud score model.

2. The computer-implemented method of claim 1, further comprising generating an interface based on the one or more of the multiple divergence pairs designated as abnormal.

3. The computer-implemented method of claim 1, wherein the segment of payment accounts includes payment accounts each having a same bank identification number (BIN).

4. The computer-implemented method claim 1, wherein generating the baseline distribution includes segregating the fraud scores for the prior similar intervals into the multiple fraud score segments across the range;
wherein generating the current distribution includes segregating the fraud scores for the target interval into the multiple fraud score segments across the range; and
wherein determining the divergence value includes determining a Kullback-Leibler (KL) divergence value based on the baseline distribution and the current distribution.

5. The computer-implemented method of claim 4, wherein the KL divergence value is determined based, at least in part, on:
$$D ( p \vert \vert q ) = \sum p ( x ) ln ( \frac{p ( x )}{q ( x )} ) dx ,$$
wherein p(x) is the current distribution and q(x) is the baseline distribution.

6. The computer-implemented method of claim 4, wherein the KL divergence value is determined based, at least in part, on:
$${D}_{KL} ( P \vert \vert Q ) = - {\sum }_{i} P ( i ) log ( \frac{Q ( i )}{P ( i )} ) ,$$
wherein P(i) is the current distribution and Q(i) is the baseline distribution.

7. The computer-implemented method of claim 4, wherein clustering the multiple divergence pairs includes applying a density-based spatial clustering of applications with noise (DBSCAN) algorithm to the multiple divergence pairs.

8. The computer-implemented method of claim 4, wherein generating the current distribution includes:
for each fraud score segment for each prior similar interval, dividing a count of the fraud scores segregated into the fraud score segment by a total number of fraud scores segregated into the multiple fraud score segments for the prior similar interval, thereby calculating a score ratio for each fraud score segment for each prior similar interval;
averaging the score ratios for the corresponding fraud score segments across the prior similar intervals, thereby generating an average score ratio for each of the multiple fraud score segments; and
defining the value included in the baseline distribution for each of the multiple fraud score segments as the average score ratio for the corresponding fraud score segment;
wherein generating the target distribution includes:
for each fraud score segment for the target interval, dividing a count of the fraud scores segregated into the fraud score segment by the total number of fraud scores segregated into the multiple fraud score segments for the target interval, thereby calculating a score ratio for each fraud score segment for the target interval; and
defining the value included in the current distribution for each of the multiple fraud score segments as the score ratio for the corresponding fraud score segment.

9. The computer-implemented method of claim 4, wherein determining the activeness of the segment of payment accounts includes determining the activeness based on a log of an average number of transitions under the segment of payment accounts for each of the prior similar intervals.

10. The computer-implemented method of claim 4, wherein the range includes a numeric range extending from 0 to 999, and wherein each numeric value in the range is indicative of a likelihood of fraud.

11. The computer-implemented method of claim 1, wherein the multiple fraud score segments include at least ten divisions.

12. A system for use in detecting anomalies in output of a fraud score model, the system comprising:
a memory including a data structure, the data structure including transaction data for a plurality of transactions involving a plurality of payment accounts associated with a plurality of segments of payment accounts, the transaction data including a plurality of fraud scores generated by at least one fraud model;
at least one processor in communication with the memory, the at least one processor configured to:
for each of the plurality of segments of payment accounts:
access, from the data structure, fraud scores for the segment of payment accounts for a target interval and for a series of prior similar intervals;
generate a baseline distribution based on the accessed fraud scores for the segment of payment accounts for the series of prior similar intervals, the baseline distribution including a value for each of multiple fraud score segments across a range;
generate a current distribution based on the accessed fraud scores for the segment of payment accounts for the target interval, the current distribution including a value for each of the multiple fraud score segments;
determine a divergence value between the baseline distribution and the current distribution for the segment of payment accounts;
determine an activeness of the segment of payment accounts based on a total number of transactions involving the payment accounts for each of the prior similar intervals, whereby the divergence value and the activeness form a divergence pair; and
cluster the multiple divergence pairs determined for the plurality of segments of payment accounts; and
designate one or more of the multiple divergence pairs as abnormal based on the clustered divergence pairs.

13. The system of claim 12, wherein the at least one processor is configured to generate an interface based on the one or more of the multiple divergence pairs designated as abnormal.

14. The system of claim 12, wherein the at least one processor is configured to, in connection with generating the baseline distribution, segregate the fraud scores for the prior similar intervals into the multiple fraud score segments across the range;
wherein the at least one processor is configured to, in connection with generating the current distribution, segregate the fraud scores for the target interval into the multiple fraud score segments across the range; and
wherein the at least one processor is configured to determine the divergence value by determining a Kullback-Leibler (KL) divergence value based on the baseline distribution and the current distribution.

15. The system of claim 14, wherein the at least one processor is configured to determine the KL divergence value based, at least in part, on:
$$D ( p \vert \vert q ) = \sum p ( x ) ln ( \frac{p ( x )}{q ( x )} ) dx ,$$
wherein p(x) is the current distribution and q(x) is the baseline distribution.

16. The system of claim 14, wherein the at least one processor is configured to determine the KL divergence value based, at least in part, on:
$${D}_{KL} ( P \vert \vert Q ) = - {\sum }_{i} P ( i ) log ( \frac{Q ( i )}{P ( i )} ) ,$$
wherein P(i) is the current distribution and Q(i) is the baseline distribution.

17. A non-transitory computer-readable storage medium including computer-executable instructions for use in detecting anomalies in output of a fraud score model, which, when executed by a processor, cause the processor to:
for each of a plurality of segments of payment accounts:
access, from a data structure, fraud scores for the segment of payment accounts for a target interval and for a series of prior similar intervals;
generate a baseline distribution based on the accessed fraud scores for the segment of payment accounts for the series of prior similar intervals, the baseline distribution including a value for each of multiple fraud score segments across a range;
generate a current distribution based on the accessed fraud scores for the segment of payment accounts for the target interval, the current distribution including a value for each of the multiple fraud score segments;
determine a divergence value between the baseline distribution and the current distribution for the segment of payment accounts;
determine an activeness of the segment of payment accounts based on a total number of transactions involving the payment accounts for each of the prior similar intervals, whereby the divergence value and the activeness form a divergence pair; and
cluster the multiple divergence pairs determined for the multiple segments of payment accounts; and
designate one or more of the multiple divergence pairs as abnormal based on the clustered divergence pairs.

18. The non-transitory computer-readable storage medium of claim 17, wherein the instructions, when executed by the processor, cause the processor to:
in connection with generating the baseline distribution, segregate the fraud scores for the prior similar intervals into the multiple fraud score segments across the range;
in connection with generating the current distribution, segregate the fraud scores for the target interval into the multiple fraud score segments across the range; and
determine the divergence value by determining a Kullback-Leibler (KL) divergence value based on the baseline distribution and the current distribution.

19. The non-transitory computer-readable storage medium of claim 17, wherein the instructions, when executed by the processor, cause the processor to, in connection with clustering the multiple divergence pairs, apply a density-based spatial clustering of applications with noise (DBSCAN) algorithm to the multiple divergence pairs.

20. The non-transitory computer-readable storage medium of claim 17, wherein the instructions, when executed by the processor, cause the processor to:
in connection with generating the current distribution:
for each fraud score segment for each prior similar interval, divide a count of the fraud scores segregated into the fraud score segment by a total number of fraud scores segregated into the multiple fraud score segments for the prior similar interval, thereby calculating a score ratio for each fraud score segment for each prior similar interval;
average the score ratios for the corresponding fraud score segments across the prior similar intervals, thereby generating an average score ratio for each of the multiple fraud score segments; and
define the value included in the baseline distribution for each of the multiple fraud score segments as the average score ratio for the corresponding fraud score segment; and in connection with generating the current distribution:
for each fraud score segment for the target interval, divide a count of the fraud scores segregated into the fraud score segment by the total number of fraud scores segregated into the multiple fraud score segments for the target interval, thereby calculating a score ratio for each fraud score segment for the target interval; and
define the value included in the current distribution for each of the multiple fraud score segments as the score ratio for the corresponding fraud score segment.
